(19) United States
(12) Patent Application Publication
(10) Pub. No.: US 2018/0133935 A1
(43) Pub. Date: May 17, 2018

(54) Faux Wood Polymeric Compound Nextura and Racking System

(71) Applicant: Bay Design, Inc., Waltham, MA (US)

(72) Inventor: Chad Ravellette, Wilton, NH (US)

(21) Appl. No.: 15/354,597

(22) Filed: Nov. 17, 2016

(51) Int. Cl. B29C 39/26; A47B 81/00; A47B 46/00; A47B 96/02; B29C 39/12; B29C 39/02

(52) U.S. Cl. CPC B29C 39/265; A47B 81/00; A47B 46/00; B29L 2031/10; B29C 39/123; B29C 39/026; A47B 96/021

(57) ABSTRACT

A system and method for the creation and utilization of a composite or polymeric material which is utilized in faux wood applications and the like, within the construction and decorative arts. Further, a material curing system including a racking apparatus a pumping system, a frame and a set of individual shelves, among other enhancement components.

### CROSS REFERENCE TO RELATED APPLICATION

This application claims the benefit of and takes priority of U.S. Provisional Application No. 62/256,394 filed on Nov. 17, 2015, and U.S. Provisional No. 62/409,154 filed on Oct. 17, 2016, the contents of which are herein incorporated by reference.

### BACKGROUND OF THE INVENTION

### Field of the Invention

The instant system relates generally to systems, apparatuses and methods of manufacture in the construction arts and more specifically to creation of novel multi-use construction material which mimics the look of certain materials, but provides enhanced strength, maintenance and usage capabilities.

### Description of the Related Art

Natural wood has been used in the construction of various products for both indoor and outdoor applications. Furniture, indoor cabinetry, flooring materials are typically made from wood. Because wood is a versatile product, it has versatile uses in society.

Natural wood is a highly desirable material, however wet conditions, expense, and environmental issues sometimes cause wood to be less desirable material to use especially for products that may be easily damaged because of the surrounding settings.

Therefore, faux wood has been developed using various synthetic polymers to mimic wood but be a more durable alternative. However, most faux wood products show a synthetic plastic look and are therefore less attractive compared to natural wood materials. Further, faux wood tends to lose the richness and desirable aesthetic features of natural wood.

### SUMMARY OF THE INVENTION

The instant apparatus and system, as illustrated herein, is clearly not anticipated, rendered obvious, or even present in any of the prior art mechanisms, either alone or in any combination thereof. A versatile system, method and series of apparatuses for creating and utilizing a very high quality specific range of quasi-wood planking and associated materials, manufactured from a proprietary lightweight plastic formulation to replicate reclaimed wood and other like systems is disclosed.

It is an objective of the instant system to introduce a quasi-wood, or wood-like material, which eradicates the corrosion breakdown issues involved with the use of actual wood or reclaimed wood for use in the construction arts.

It is also an object of the instant invention wherein the system is disposed to detect when a vehicle enters an unhealthy food venue and alert the operator of numerous healthier choices within a designated radius.

The methods described herein do not rely on fixed geometry forms as the engineered mixture, once brought to the desired thickness and proper rigidity, may be cut to adjustable shapes and dimensions, thereby allowing separation, and later curing in a racking system. In addition, the ambient conditions surrounding the now separated curing panel(s), cured when stationed within the racking system, may be controlled so as to enhance production rates, and quality assurance.

Moreover, the high-performance environmentally friendly building panel manufacturing steps including the cutting, thickness fine adjustment system, and final curing processes by positioning the resulting high-performance building panel into an environmentally controlled racking system, in accordance with an example embodiment.

There has thus been outlined, rather broadly, the more important features of the versatile construction materials and methods of creation embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be made to the accompanying drawings and descriptive matter in which there are illustrated preferred embodiments of the invention.

The above summary of the present invention is not intended to describe each disclosed embodiment or every implementation of the present invention. The Figures, Detailed Description and Examples which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 describes a technical overview that illustrates the instant Nextura Line;

FIG. 2 illustrates the very high quality specific range of wood planking and associated material, manufactured from a proprietary lightweight formulation, in some cases a plastic formulation, to replicate reclaimed wood Nextura Line;

FIG. 3 illustrates an isometric or perspective view of the JB 1000 Racking system, illustrating the frame and the several height staggered racks, with one rack outwardly disposed;

FIG. 4 illustrates an isometric or perspective view of a portion of an individual rack of the JB 1000 Racking system, further illustrating the individual components of an individual rack, including the mixing nozzle wherein the liquid resin materials are received from the mixing area via a pump and a piping or hose system, directed to a mixing nozzle. The mixing nozzle delivers the mixed materials to the shelves located on the racking system. Prior to pouring the mixed material into the shelving molds the texture mats are set in place;

FIG. 5 illustrates an isometric or perspective view of a portion of an individual rack of the JB 1000 Racking system, further illustrating the individual components;

FIG. 6 illustrates an isometric or perspective view of a portion of an individual rack of the JB 1000 Racking system, further illustrating the individual components;

FIG. 7 illustrates an isometric or perspective view of numerous juxtaposition JB 1000 Racking systems, illustrating the frame and the several height staggered racks, with the racks inwardly disposed;

FIG. 8 illustrates an isometric or perspective view of a portion of an individual rack of the JB 1000 Racking system, further illustrating the individual components;

FIG. 9 illustrates an isometric or perspective view of a portion of an individual rack of the JB 1000 Racking system, further illustrating the individual components;

FIG. 10 illustrates an isometric or perspective view of the JB 1000 Racking system, illustrating the frame and the several height staggered racks, with one rack outwardly disposed;

FIG. 11 illustrates an isometric or perspective view of a portion of an individual rack of the JB 1000 Racking system, further illustrating the individual components;

FIG. 12 illustrates an isometric or perspective view of a portion of an individual rack of the JB 1000 Racking system, further illustrating the individual components;

FIG. 13 illustrates an isometric or perspective view of the JB 1000 Racking system, illustrating the frame and the several height staggered racks, with one rack outwardly disposed;

FIG. 14 illustrates an isometric or perspective view of an individual a set of board length partitions utilized in one embodiment;

FIG. 15 illustrates an exploded perspective view of an individual of the set of board length partitions utilized in one embodiment;

FIG. 16 illustrates a perspective view of the JB 1000 Racking system, illustrating the rack frame may be fabricated using welded connections with carbon steel structural framing and the lower base framing tubing;

FIG. 17 illustrates an exploded isometric or perspective view a corner portion of the rack frame further illustrating the structural interface of the square tubing, horizontal member and the v-groove track rollers;

FIG. 18 illustrates a further embodiment of the divider end plates;

FIG. 19 illustrates an additional embodiment of the divider end plates communicating with a retaining rod; and,

FIG. 20 illustrates an additional embodiment of the retaining rod mechanism.

### DETAILED DESCRIPTION OF THE SEVERAL EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

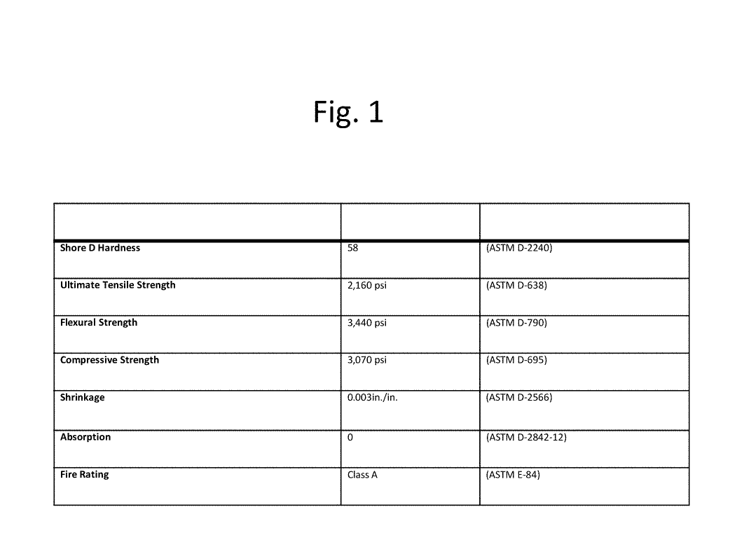

Referring to the figures, FIG. 1 describes a Technical Overview that illustrates the instant Nextura or Nextura™ Line meets or exceeds IBC Requirements and Regulations for use in commercial and residential applications.

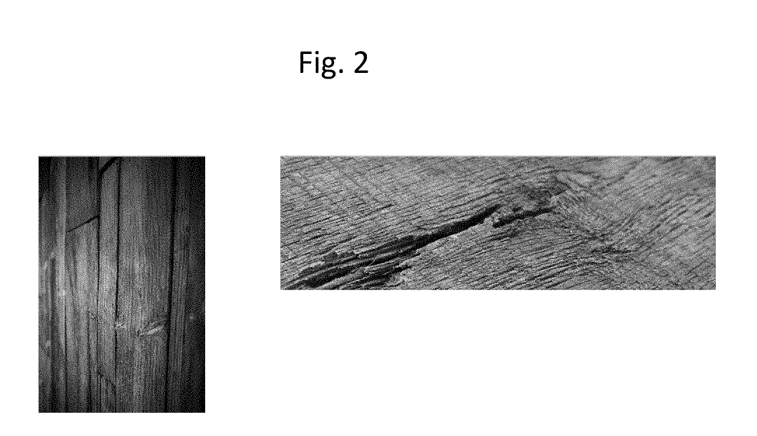

As illustrated in FIG. 2, the Nextura™ Brand consists of a very high quality specific range of wood planking and associated materials, manufactured from a proprietary lightweight plastic formulation to replicate reclaimed wood. The Nextura™ line of products were developed to meet the need for a high quality sustainable product that looks and feels like natural wood, has all the positive attributes of natural wood, while at the same time overcoming the limitations of natural wood.

The Nextura™ Line can be used for interior and exterior wall claddings, ceilings, beam wraps, column wraps, back splashes, shower walls and much more.

The composite or polymer wood planking may be offered in a set line of textures, colors and dimensions, with the ability to offer the product in a virtually unlimited range of textures, sizes and quantities should the need arise for specific projects.

The instant system additionally possesses numerous Performance Advantages as the product can be milled, fastened and used in much the same fashion as natural reclaimed wood with the added benefit of seamless joints when required.

Moreover, the Nextura™ Line has been designed with customers and installation crews alike in mind as the system and materials comprise a construction that is simple to work. The product can be face screwed, glued, epoxy adhered, installed with hidden fastening systems or even pneumatically nailed.

Addressing the surface finishing aspects, all products under the Nextura™ Line come with a high end finish and the coloring process utilized involves the use of UV stable pigments for integral color throughout the board. In addition a hand applied topcoat provides an authentic look that is indistinguishable from natural wood. Our unique finishing techniques developed by our designers allow for the natural beauty of wood to show through by providing subtle differences from board to board. The result is the most realistic and durable look available on the market in the state of the art. Additionally, surface sealer may be applied by the end user should a high gloss finish be desirable.

The instant system further comprises a heavily filled low-density urethane casting resin and the cured plastic is lightweight and has a much lower density than other casting resin. The instant system features convenient 1A:1B volume mix ration and mixes easily (pre-mixing of parts A & B is necessary). Cured plastic is strong and can be carved, machined, drilled, sanded, etc. The instant system can be pigmented with SO-Strong® color tints prior to casting and finishing castings can be painted. And, because this product is low-density, it yields more plastic per pound/kg than other casting resins—thus the cost per casting is appreciably low.

The instant system can additionally be employed for a variety of art or industrial design related applications including reproducing sculpture, making fishing lures, prototype model making, casting doll heads and figures, etc.

Addressing processing recommendations, the below parameters may be utilized in order to ensure maximum material production and capabilities as follows:

Preparation—Store and use at room temperature (73°/23° C.). These products have a limited shelf life and should be used as soon as possible. Environmental humidity should be as low as possible. Good room size ventilation is essential. Wear safety glasses, long sleeves and rubber gloves to minimize contamination risk.

Applying a Release Agent—A release agent is necessary to facilitate de-molding when spraying into or over most surfaces. Use a release agent made specifically for mold making (Universal Mold Release available from Smooth-On or your Smooth-On Distributor). A liberal coat of release agent should be applied onto all surfaces that will contact plastic. Most silicone rubber molds usually do not require a release agent. Using a release agent, however, will prolong the life of the mold.

One note of high import, the user should apply release agent to all surfaces that will contact rubber. To ensue thorough coverage, lightly brush the release agent with a soft brush over all surfaces of the model. Follow with a light mist coating and let the release agent dry for 15 minutes.

Mixing—Material is heavily filled and the filler will separate from the liquid during storage. When the user first opens containers, the user will see powder on top that must be thoroughly pre-mixed with liquid on the bottom. The user must stir both Part A & Part B well before using—Pre-mix both parts in their original containers before dispensing. After dispensing equal amounts of Parts A & B into mixing container and mix thoroughly.

Furthermore, the user should stir slowly and deliberately, ensuring to scrape the material from the sides and bottom of the mixing container several times to ensure proper formation, while being careful not to splash any low viscosity material out of container. The user should also be mindful that the material sets up quickly and thus no room exists for delay between mixing and pouring.

Next in line is the pouring process, wherein fumes may be visible as this product starts to “gel” and cure, will dissipate with adequate ventilation. Only use this product with room size ventilation and do not inhale/breath fumes. Casting will be extremely hot immediately following cure and may burn the skin. Let cool to room temperature before handling. For best results, pour your own mixture in a single sport at the lowest point of the containment field and let the mixture seek its level. This will help minimize air entrapment.

One important feature Shelf life of a product is reduced after opening. Remaining product should be used as soon as possible. Immediately replacing the lids on both containers after dispensing product will help prolong the shelf life of unused product. Dry Glass Blanket or some other functional equivalent will significantly prolong the shelf life of unused liquid urethane products.

The Curing Process comes next, and once again, fumes, which may be visible as this product starts to “gel” and cure will dissipate with adequate ventilation. Castings will be extremely hot immediately following cure and may burn the skin. Let cool to room temperature before handling. The material is readily for de-mold in about two hours depending on mass and mold configuration.

Following the Curing Process is naturally the post Curing Process. In Post curing a casting is not necessary but will increase physical properties and performance. The material should be allowed to cure for recommended cure time at room temperature followed by 4-6 hour at 150° F./65° C. Casting should be allowed to come to room temperature before handling.

Performance—Cured castings of the instant system are lightweight, rigid, and durable. They resist moisture, moderate heat, solvents, dilute acids, and can be machined, primed/painted or bonded to other surfaces (any release agent must be removed). If machining the cured material, wear dust mask or other apparatus to prevent inhalation of residual particles.

In numerous embodiments, the system may utilize constructions and materials such as a laminate with hemp board, cork board and Medium-density fibreboard (MDF) which is an engineered wood product made by breaking down hardwood or softwood residuals into wood fibres, often in a defibrator, combining it with wax and a resin binder, and forming panels by applying high temperature and pressure. MDF is generally denser than plywood. It is made up of separated fibres, but can be used as a building material similar in application to plywood. It is stronger and much denser than particle board.

Furthermore, to provide a brief description of manufacturing process, the method steps may comprise the following:
1. Raw Materials for our proprietary mix design are delivered and stocked.
2. The Liquid resin materials are hooked up to a pump system.
3. The pump system deliverers the liquid resin materials through hoses to a mixing nozzle.
4. The mixing nozzle is located at the JB1000 Racking system and delivers the mixed materials to the shelves located on the racking system.
5. The JB 1000 Racking system will be constructed per the figures attached herein.
6. Prior to pouring the plastic mix material into the shelving molds the texture mats are set in place.
7. Texture mats will be of different surface textures and sizes depending on the requirements.
8. For surface color only, the required color pigment is brushed onto the texture mats prior to the liquid resin material being poured into the shelving molds.
9. For integral color the color pigment is brushed onto the texture mats and also measured and mixed into the liquid resin material prior to the liquid resin material being poured into the shelving molds.
10. The liquid resin material is poured into the shelving molds at ¼ inch thickness for our laminate material.
11. For our ¾″ dimensional boards the liquid resin material is allowed to set up and then a backing mix of liquid resin material with filler is added on top to achieve a thickness of ¾ inch.
12. After material has cured for approximately 2 hours, the user should remove the cured material from the shelving.
13. The cured material undergoes QC checks and is sent down the line to shipping.
14. The material is packaged and labeled for delivery to customers.

Moreover in one embodiment, creation of a Nextura™ Manufacturing Process Break Down. The creation of a Nextura™ synthetic wood board starts with the mold prep. Molds of different species and textures of wood are coated with a universal mold releasing agent. After the release agent is applied, artisans will color each mold individually using a mixture of mineral spirits and UV resistant urethane pigments. At this time parts A and B of our urethane plastic will be weighted out specific to the intended mold.

Once the color is brushed onto the molding surface, the user may mix urethane pigment color into our parts A and B of our urethane plastic. Once desired color is achieved, the user may mix parts A and B together for approximately one minute and pour the product into the mold, letting it flow against a pour plate to prevent any of the colors brushed in the mold from being washed of the mold surface due to a heavy pour.

Next, the user may fill the mold to the desired thickness (different for each mold texture) and then insert our backing while product is still wet to allow for a proper bond of the two products. Then the backer is clamped into place to make sure all air has been forced out and any excess urethane is squeezed out so the final product is at the desired thickness.

After 15 minutes, the user should unclamp and scrape any excess material from the mold frame and back of the backer while product is still not fully cured. After another 10 to 15 minutes the finished product is ready to be demolded to revile the final texture and coloring. Then the board gets a few passes through the saw to clean up the edges and bring board to final production size. After a final inspection the boards are packaged and reading for shipment.

Below is a list of Possible Backing Materials, including but not limited to the following:

Homasote

Hemp Board

MDF

PVC

Cork

Plywood

Cement Board

Sheetrock

Gypsum

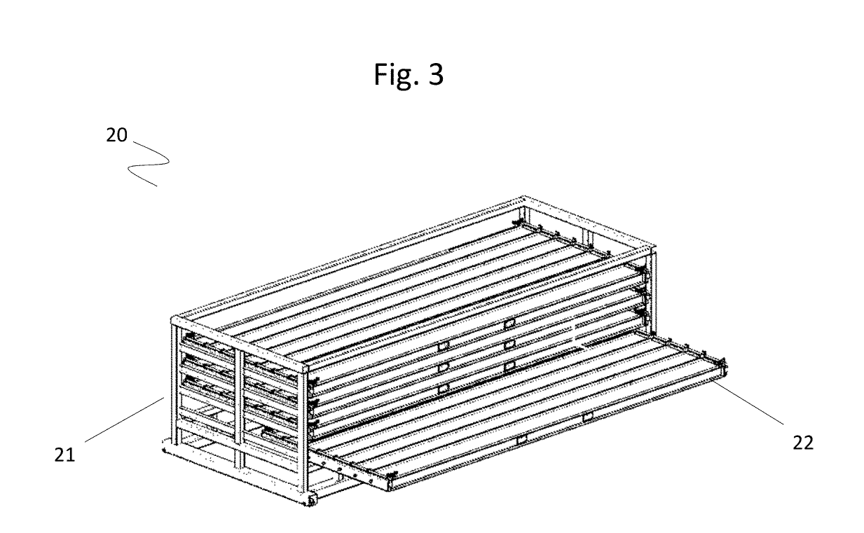

Turning to FIG. 3, the JB 1000 Racking System 20 is illustrated, wherein the materials may be cured. The racking system comprises of a frame 21 with several height staggered racks 22. In some embodiments, the staggered racks 22 may be drawer-like and have the option for the user to pull out racks to access the product or monitor the product.

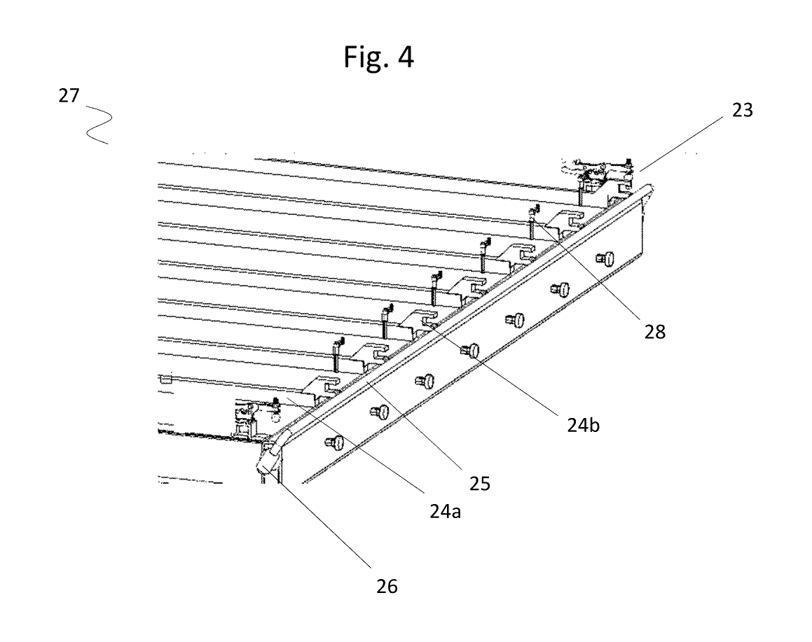

FIGS. 4-6 illustrate a blown up view of an individual rack 27. The figure also illustrates the individual components of an individual rack. The individual rack 27 may comprise of the mixing nozzle, wherein the liquid resin materials are received from the mixing area via a pump and a piping or hose system, directed to a mixing nozzle. The mixing nozzle delivers the mixed materials to the shelves located on the racking system. Prior to pouring the mixed material into the shelving molds the texture mats are set in place.

In one embodiment, each individual rack comprises a series of dividers 24a, a retaining rod 25 that is capable of sliding into each of a set of dividers 24a, through the use of divider end plates 24b. Quick clamps 23 may clamp down the retaining rod 25 to both sides of the shelf. In one embodiment, the retaining rod 25 is pivotally in communication with the individual shelf by a socket mechanism 26. In certain embodiments, the series of dividers 24a may be secured to the shelving system to prevent movement by a series of divider pin mechanisms 28.

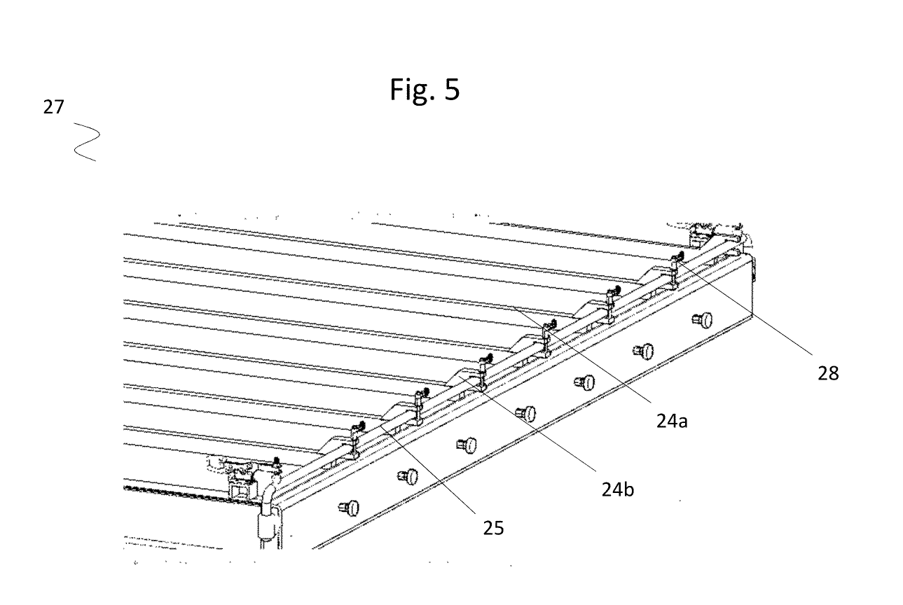

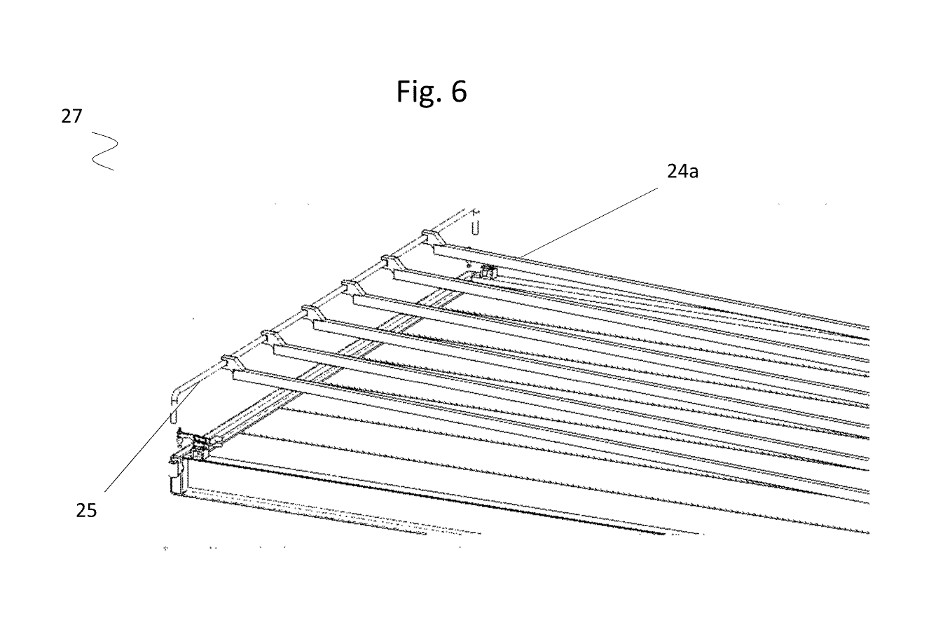

FIG. 5 illustrates another embodiment of the apparatus wherein the retaining rod 25 is in a locked position within the set of dividers 24a. As shown the divider end plates 24b and the divider pin mechanisms 28 ensure the retaining rod is locked in place. FIG. 6 illustrates yet another embodiment, wherein the set of dividers 24a, and the retaining rod 25 are shown and how they are in communication with the individual rack 27.

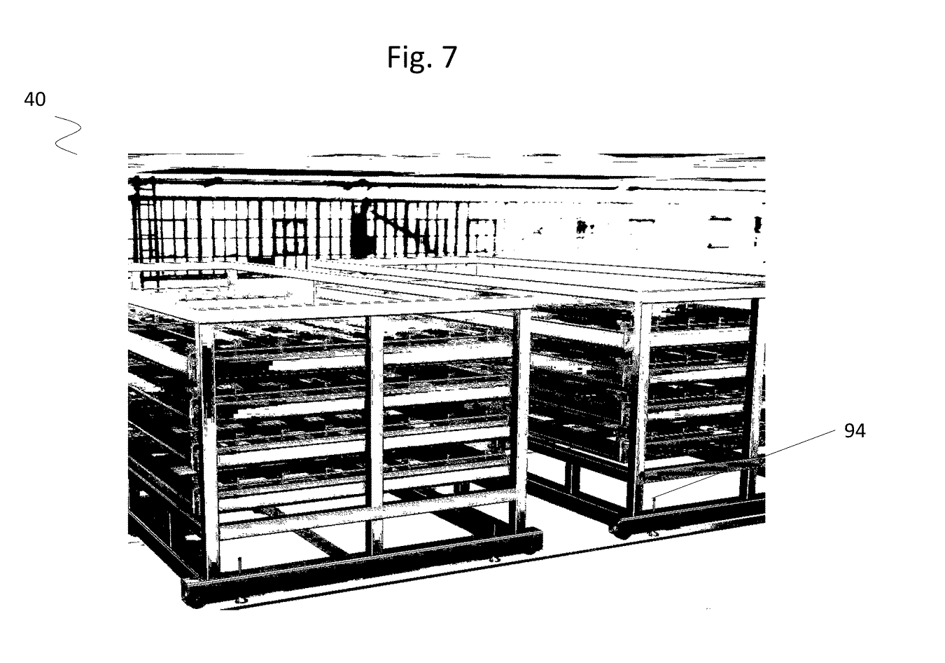

In an additional embodiment of the JB 1000 Racking System 40, addressing FIG. 7, in one embodiment, an array of individual JB 1000 Racking Systems 40, in tandem, is pictorially illustrated. A stopper 94 securing system (discussed in detail herein below) is utilized to retain the individual JB 1000 Racking systems 40 in place.

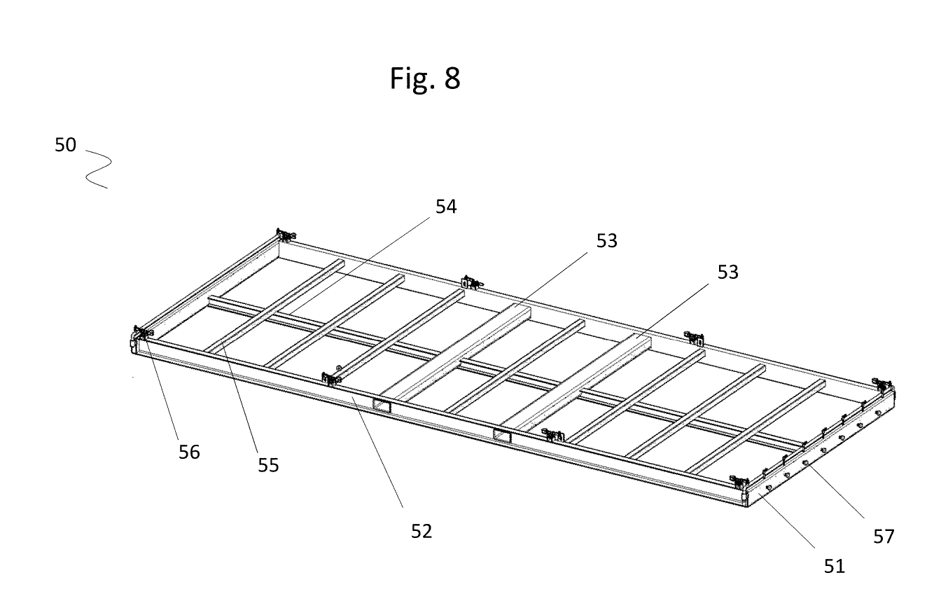

Addressing FIG. 8, in one embodiment, the racking system 40 may comprise a set of shelf mechanisms, of which an individual shelf mechanism 50 is depicted. Each individual shelf mechanism 50 comprises a structure framing system wherein some of the components utilized may comprise 6061 aluminum. The interiorly disposed dimensions of the exterior frame may be 20′-2″×7′-7 11/16.″ The longer side members 52 outside members may comprise 6″ C channels. The shorter side members 51, or end members, may comprise 6″×2″×¼″ thick rectangular tubes. Additionally, two ⅜″×4″×7″ rectangular tubes 53 may span the width of the frame and protrude through the C channels in order to provide fork truck loading points.

Furthermore, a single 3″ I-beam 54 may be disposed to run in the lengthwise or long direction at the center of each shelf 50 and a set of 2×2×⅛″ square support tubing 55 may span the width of the shelf 7 places to support the shelf floor. The shelf floor 62 (not shown herein for clarity purposes), may comprise ⅛″ thick aluminum plate. The framing connections may be welded construction. The approximate unloaded weight of each shelf may be 1100 to 1300 lbs.

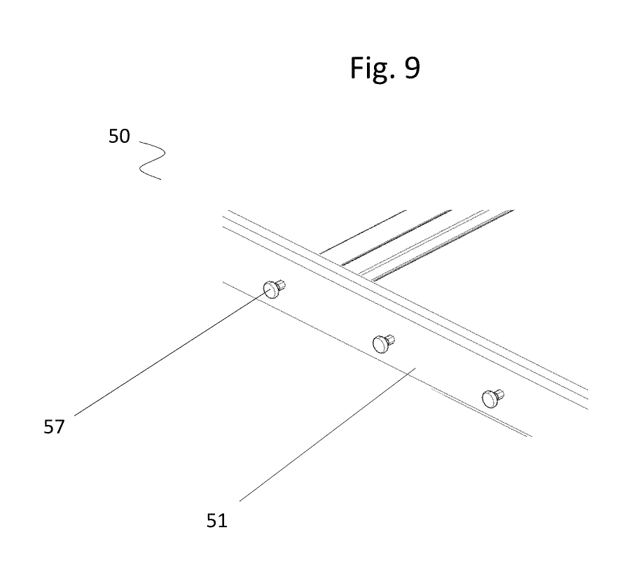

Addressing FIG. 9, in one embodiment, each frame may be supported in the rack and slide in two directions via track rollers. Threaded aluminum studs may be welded to the end framing members 51 and seven heavy-duty track rollers 57 may be threaded into each stud. Each track roller 57 is capable of supporting 300 lbs.

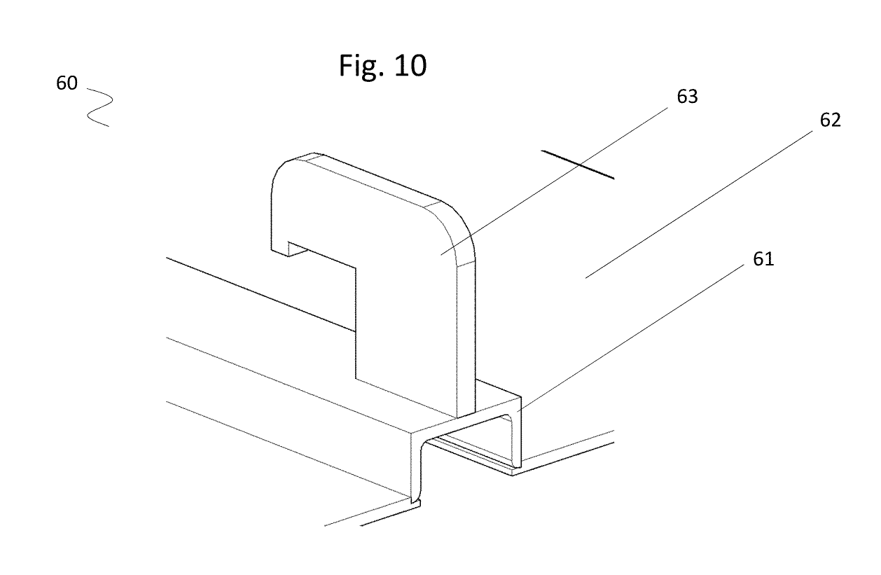

Further, addressing FIG. 10, in one embodiment, the series of dividers 61 may be constructed using 3″×1½″×¼″ 6061 aluminum channel. The overall length of each divider 61 may be 20′-1¾″ long. In one embodiment, ½″×4¼″×5½″ aluminum lugs may be welded to each end. The lugs may be slotted to hold a removable length of aluminum square tubing that may be used to apply down pressure to all dividers once they are set in place. The shelf floor 62 (not shown herein for clarity purposes), may comprise ⅛″ thick aluminum plate.

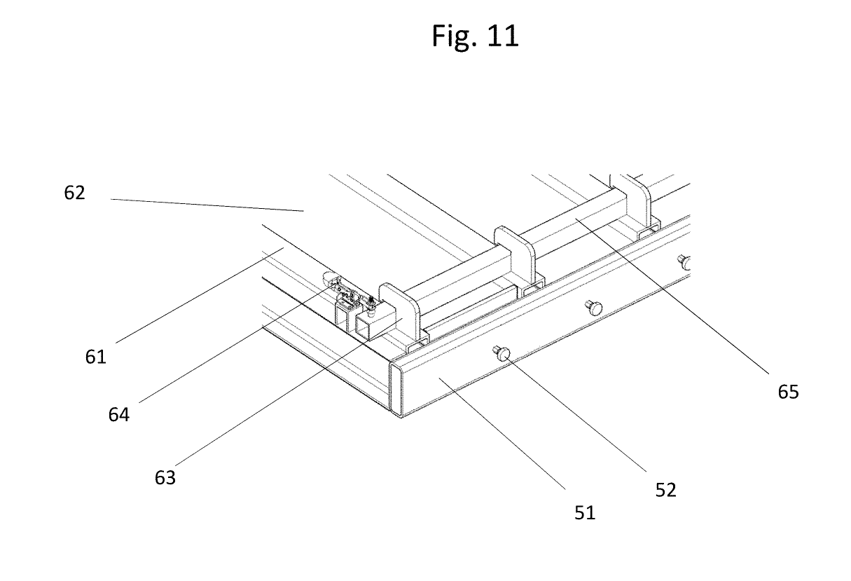

Regarding FIG. 11, in a further embodiment, instead of a retaining rod as shown in earlier figures, a 2″×2″×¼″ square aluminum tube 65 may slide into each of a set of divider end plates 63 and may be clamped down with quick clamps 64 mounted on both sides of the shelf. The shelf floor 62, may comprise ⅛″ thick aluminum plate.

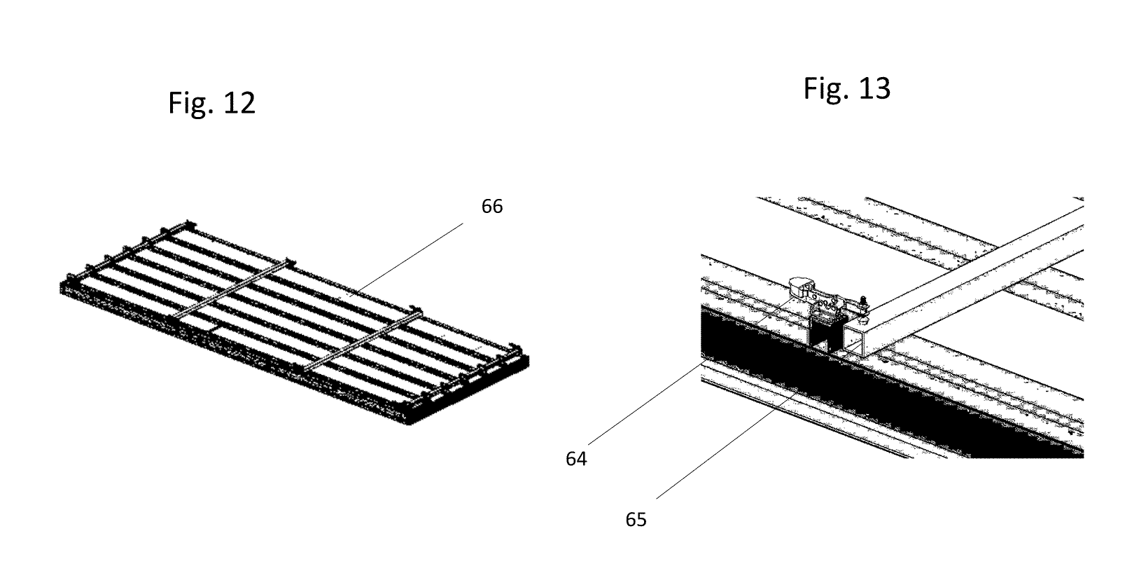

Addressing FIGS. 12 and 13, in one embodiment two additional down pressure tube assemblies 66 may be equally spaced from the center line of the shelf. These may help to apply down pressure along the entire length of the divider 61. FIG. 13 shows an enlarged area of the racking system particularly an enlarged detail version of the square aluminum tube 65 and the quick clamps 64, which mount the aluminum tube to both sides of the shelf.

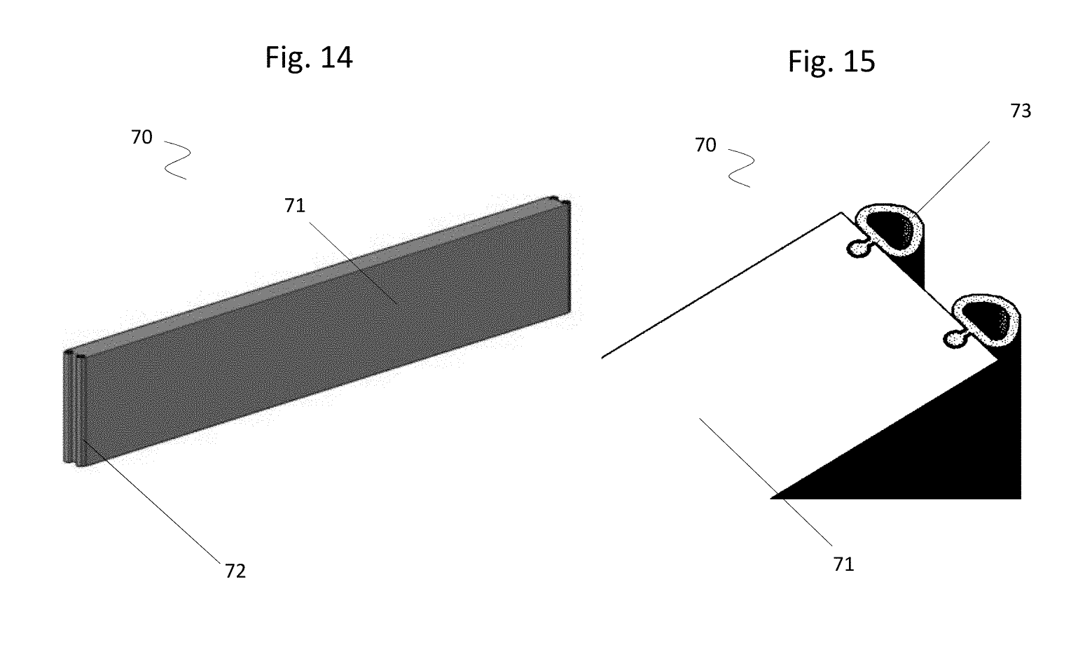

Concerning FIGS. 14 and 15, in one embodiment, the system may comprise a set of board length partitions 70 which may comprise a body 71 composed in one embodiment from a plastic material. The partition ends may comprise a set of grooves 72 disposed to accept a set of rubber gaskets 73.

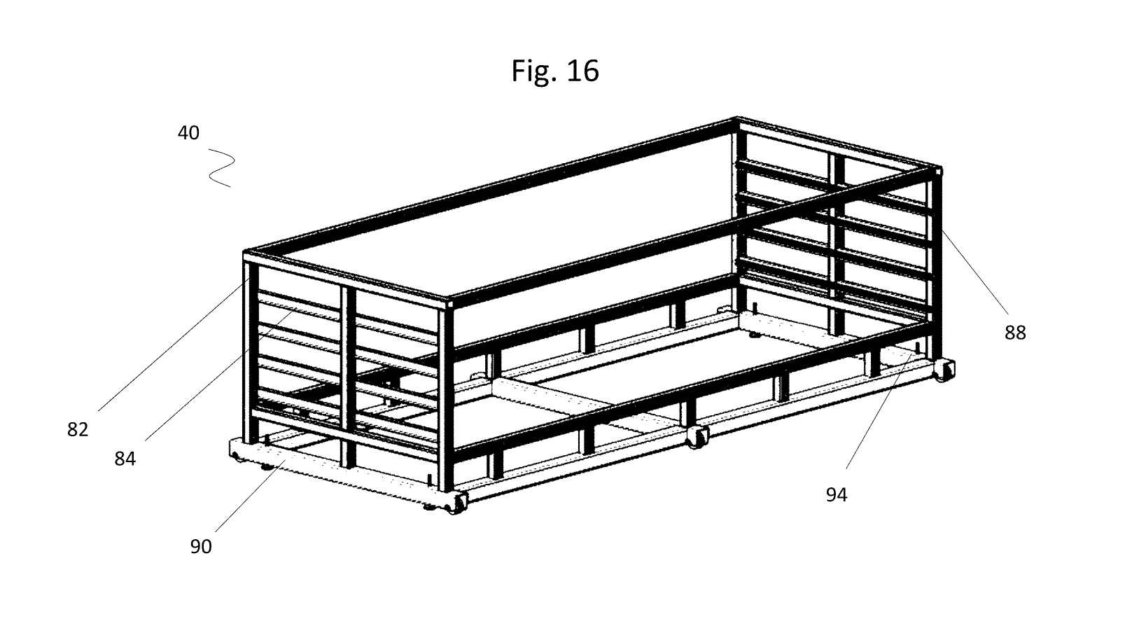

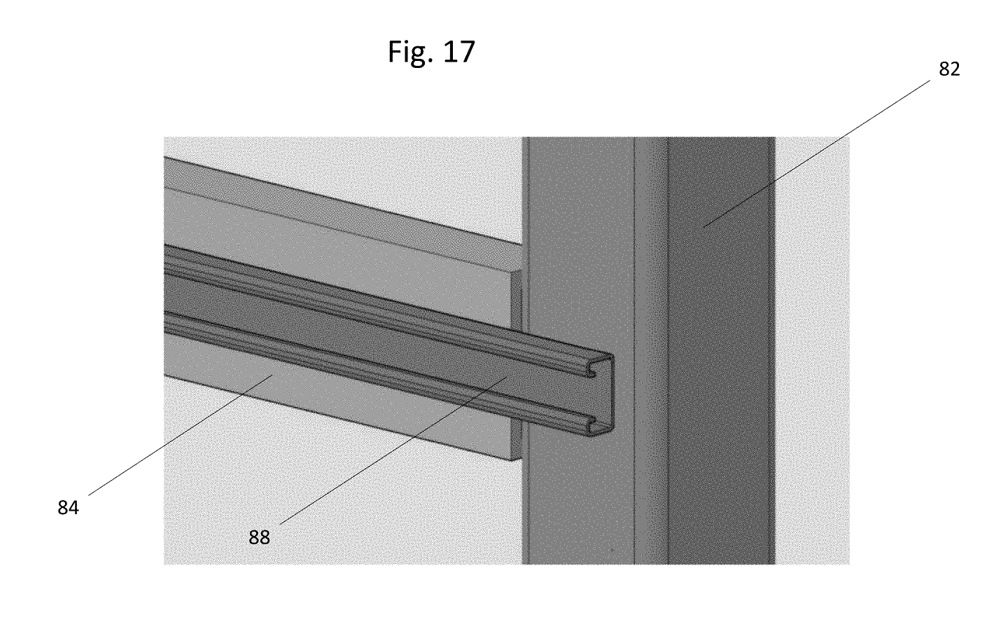

Investigating FIGS. 16 and 17, in one embodiment the rack frame 40 may be fabricated using welded connections with carbon steel structural framing. The rack frame 40 may comprise the lower base framing tubing 90. The balance of framing (blue) may be 4×4××¼″ square tubing 82 may be 6×6×⅜″ square. A set of horizontal members 84 (green) are disposed to support the shelves 50 may be C4×7.25 channel. The frame system may be equipped with v-groove track rollers 88. The frame system may be equipped with adjustable leveling screws. Each of the shelves may be supported on track rollers. The tracks may be welded to the frame.

FIG. 17, illustrates an exploded isometric view of a corner portion of the rack frame 40 further illustrating the structural interface of the square tubing 82, horizontal member 84 and the v-groove track rollers 88.

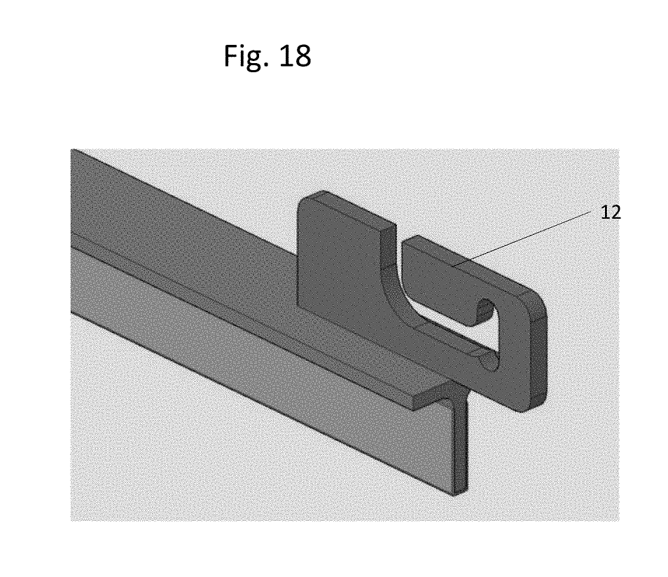

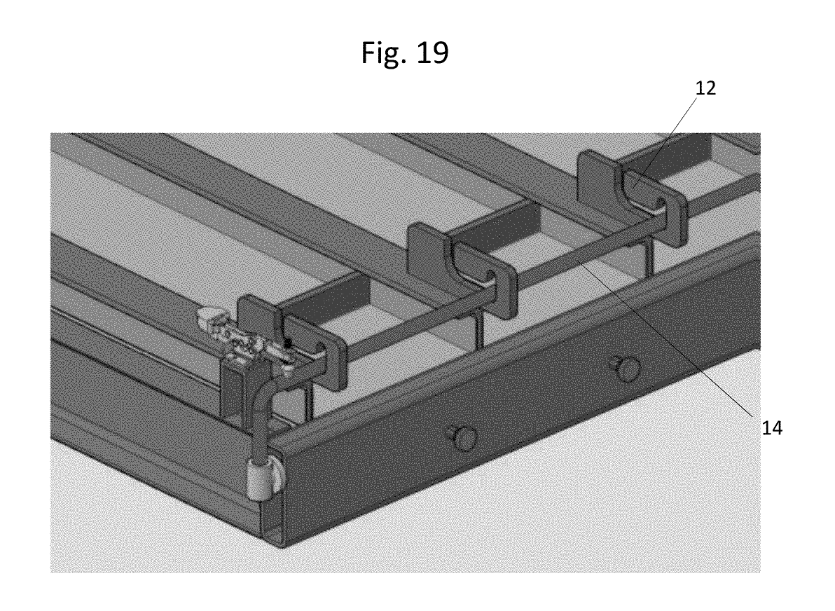

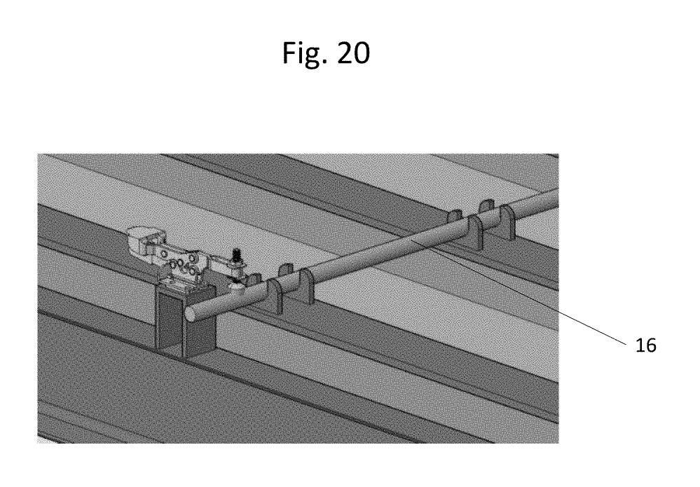

FIG. 18 illustrates yet another embodiment of the divider end plates 12. In further embodiments the shape may vary in design and material. As seen in FIG. 19 the additional embodiment of the divider end plates 12 shown in communication with a retaining rod 14. Finally, FIG. 20 illustrates an additional embodiment for the retaining rod mechanism 16.

1. A method of manufacturing a faux wood product comprising the steps of:
a. utilizing raw materials;
b. aligning a pump system with a set of liquid resin material containment tanks comprising a quantity of liquid resin material;
c. positioning and aligning a mixing nozzle mechanism at a racking system
d. delivering the liquid resin materials through hoses to the mixing nozzle mechanism at the racking system;
e. positioning a set of texture mats prior to pouring the mixed liquid resin material into a set of shelving molds located on the racking system;
f. delivering the mixed liquid resin material into the set of shelving molds; and
g. allowing the mixed liquid resin material to cure.

2. The method of manufacturing a faux wood product of claim 1 further comprising the step of creating a laminate material.

3. (canceled)

4. The method of manufacturing a faux wood product of claim 2 further comprising the steps of:
allowing the mixed liquid resin material to set up; and,
applying a backing mix of mixed liquid resin material with filler onto an upper layer of the set up mixed liquid resin material in order to achieve a thickness of ¾ inch.

5. The method of manufacturing a faux wood product of claim 4 further comprising the steps of:
allowing the mixed liquid resin material to cure for 2 hours to form a cured material;
removing the cured material from the shelving; and,
performing quality control checks on the cured material.

6. (canceled)

7. (canceled)

8. (canceled)

9. The method of manufacturing a faux wood of claim 1 further comprising the steps of:
brushing the required color pigment onto the texture mats for surface color;
pouring the liquid resin material into the shelving molds.

10. (canceled)

11. A racking system comprising:
a main body comprising:
a frame mechanism;
and, a stopper mechanism; and,
a set of shelf mechanisms wherein each individual of the set of shelf mechanisms comprises a structure framing system.

12. (canceled)

13. (canceled)

14. (canceled)

15. (canceled)

16. The racking system of claim 11 wherein the shelf mechanism framing system further comprises a set of longer sides and a set of shorter sides.

17. The racking system of claim 11 wherein the longer side members outside members comprise a set of 6″ C channels.

18. (canceled)

19. (canceled)

20. (canceled)

21. (canceled)

22. (canceled)

23. (canceled)

24. (canceled)

25. The racking system of claim 11 wherein each individual of the shelf mechanisms is slidably contained within the racking system and wherein each individual of the shelf mechanisms comprises track rollers and slides in two directions via track rollers.

26. (canceled)

27. (canceled)

28. The racking system of claim 11 further comprising a set of divider mechanisms.

29. (canceled)

30. (canceled)

31. (canceled)

32. (canceled)

33. (canceled)

34. (canceled)

35. (canceled)

36. The racking system of claim 11 further comprising at least two additional down pressure tube assemblies.

37. The racking system of claim 36 wherein the at least two additional down pressure tube assemblies may be equally spaced from the center line of the shelf and apply downward pressure along the entire length of the divider.

38. The racking system of claim 11 further comprising a set of board length partitions.

39. The racking system of claim 11 wherein the set of board length partitions comprise a material selected from the group consisting of polymeric materials, composite materials and plastic material.

40. (canceled)

41. (canceled)

42. (canceled)

43. (canceled)

44. (canceled)

45. (canceled)

46. The racking system of claim 11 wherein the rack frame comprises a set of lower base framing wherein the set of lower base framing comprises square tubing.

47. (canceled)

48. The racking system of claim 11 further comprising a set of horizontal members wherein the set of shelf mechanisms are supported on the set of horizontal members.

49. (canceled)

50. (canceled)

51. The racking system of claim 11 wherein each individual of the shelve mechanisms comprises a set of track rollers wherein each individual of the shelve mechanisms is supported on track rollers.

52. (canceled)

53. (canceled)

54. A racking system comprising:
a pumping system;
a frame;
a set of individual shelves;
a mixing nozzle wherein the mixing nozzle delivers the mixed materials to the set of individual shelves located on the racking system;
a set of divider blades;
a set of divider blade pins;
a locking bar; and,
a set of texture mats.
